(19) United States
(12) Patent Application Publication
(10) Pub. No.: US 2005/0278042 A1
(43) Pub. Date: Dec. 15, 2005

(54) Fully digital audio output device

(76) Inventor: Sung-Jung Wu, Banciao City (TW)

Correspondence Address: TRANSPACIFIC LAW GROUP, 617 NORTH DELAWARE STREET, SAN MATEO, CA, 94401, US

(21) Appl. No.: 10/855,473

(22) Filed: May 26, 2004

(51) Int. Cl. G06F 17/00

(52) U.S. Cl. 700/94

(57) ABSTRACT

The fully digital output device of this invention comprises: a communication interface connector to electrically connect a communication interface of a computer; a communication interface converter to convert signals and data obtained from said communication interface connector into a first format and to convert signals and data to be transferred to said communication interface into a second format; a digital signal converter to convert said first format digital audio signals into a third format and to output such third format signals; a buffer memory to store said second format digital audio signals of said communication interface converter to be processed by said digital signal converter; and a power management circuit to manage to output current obtained from said communication interface connector along with said third format digital signals of said digital signal converter; wherein said third format digital signal is used to drive a speaker directly. The fully digital audio signal output device may further comprise a speaker, to be driven by said third format digital signal to generate sound.

### FIELD OF THE INVENTION

The present invention relates to a fully digital audio output device, especially to a fully digital audio output device connected to computer equipment through a communication interface.

### BACKGROUND OF THE INVENTION

In a traditional computerized audio system, the digital audio signals are first transformed into analog signals, output to a speaker or earphone equipped with an amplifier, such that the content of the digital audio file which is stored in a computer equipment may be replayed.

FIG. 1 shows the systematic diagram of a traditional computerized audio output device. As shown in this figure, a computerized audio output device comprises: a digital to analog converter 2, installed in or connected to a computer equipment 1, to convert the output digital audio signals of the computer 1 into a digital format; an amplifier 3 to amplify the analog signals generated by the digital to analog converter 2 and to output the amplified signals to the speakers 4; and a power supply 5, connected to the amplifier 3, to supply power to drive the speakers 4. In such a system, the digital to analog converter 2 may be an interface card installed in the computer 1, such as the famous Sound Blaster, or a integrated circuit chip installed in or connected to the computer 1, such as an AC97COPEC chip etc. The output signals of the digital to analog converter 2 are small in power and needs to be amplified by the amplifier to drive the speakers 4. A speaker equipped with amplifier is called an active speaker. An active speaker is heavy, not portable or even is difficult to move. In addition, the power supply 3 adds additional costs to the device and makes the device not portable. Nevertheless, if the digital to analog converter 2 is equipped inside the computer 1, noises generated by the computer 1 will be included in the output analog signals, making the sound quality poor.

Due to the development of the USB interface, many “USB audio” products were announced in the market. FIG. 2 shows the systematic diagram of a USB audio output device. In this figure, elements that are same as those in FIG. 1 are labeled with the same numbers. As shown in FIG. 2, in a USB audio output device the digital to analog converter 2 is provided at the speaker 4 side and is connected with the computer 1 by a cable through the USB interface 11 of the computer 1. In such a device, a USB interface converter 6 is provided to convert the output USB signals of the computer 1 into formats acceptable to the digital to analog converter 2. Such a USB audio output device has the benefit of lower noise contained in the audio signals and clean sound quality. It is convenient to use, since digital audio signals are received from the USB interface. However, as the digital to analog converter is a high cost component, the USB audio output device is expensive. In addition, the amplifier 3 and the power supply 5 are necessary components of such a device, making it not portable.

It is thus necessary to provide a full digital audio output device.

It is also necessary to provide an audio output device wherein no amplifier and external power supply are needed.

It is also necessary to provide a low-cost and high performance audio output device.

It is also necessary to provide a convenient and portable audio output device.

### OBJECTIVES OF THE INVENTION

The objective of this invention is to provide a full digital audio output device.

Another objective of this invention is to provide an audio output device wherein no amplifier and external power supply are needed.

Another objective of this invention is to provide a low-cost and high performance audio output device.

Another objective of this invention is to provide a convenient and portable audio output device.

### SUMMARY OF THE INVENTION

According to this invention, a fully digital audio output device is provided. The fully digital output device of this invention comprises:
a communication interface connector to electrically connect a communication interface of a computer;
a communication interface converter to convert signals and data obtained from said communication interface connector into a first format and to convert signals and data to be transferred to said communication interface into a second format;
a digital signal converter to convert said first format digital audio signals into a third format and to output such third format signals;
a buffer memory to store said second format digital audio signals of said communication interface converter to be processed by said digital signal converter; and
a power management circuit to manage to output current obtained from said communication interface connector along with said third format digital signals of said digital signal converter;
wherein said third format digital signal is used to drive a speaker directly.

The fully digital audio signal output device may further comprise a speaker, to be driven by said third format digital signal to generate sound.

These and other objectives and advantages of this invention may be clearly understood from the detailed description by referring to the following drawings.

### BRIEF DESCRIPTION OF THE DRAWINGS

FIG. 1 shows the systematic diagram of a traditional computerized audio output device.

FIG. 2 shows the systematic diagram of a USB audio output device.

FIG. 3 shows the systematic diagram of the fully digital audio output device of this invention.

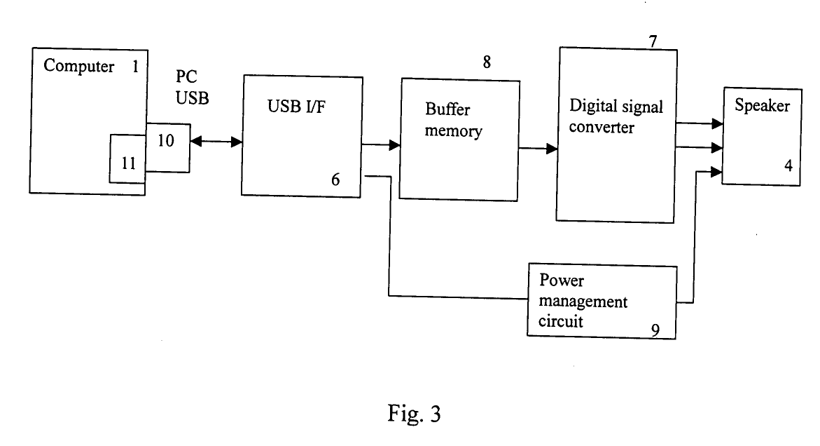

FIG. 4 shows the flowchart of the initialization of the fully digital audio output device of this invention.

### DETAILED DESCRIPTION OF THE INVENTION

Along with the newly development of the networking technology, most analog devices are replaces by digital devices. The digital signal is easy to calibrate and to divide. Transmission efficiency for the digital signal is far better than that of the analog signal. Although it is not intended to limit the scope of this invention, it has been found that no external power supply will be needed, if a speaker is driven by digital signals directly. I is also found that the speaker may be driven by the current supplied by the communication interface of the computer equipment to generate desired sound effects. Under the current USB standard, power supplied to the bus is limited to under 500 mA. If the power consumption of the speaker or the earphone is controlled to be within such scope, it is possible to use the power as obtained from the USB interface to drive the speaker.

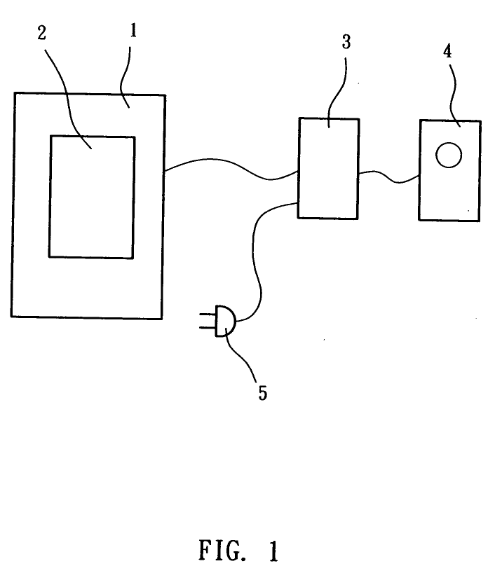

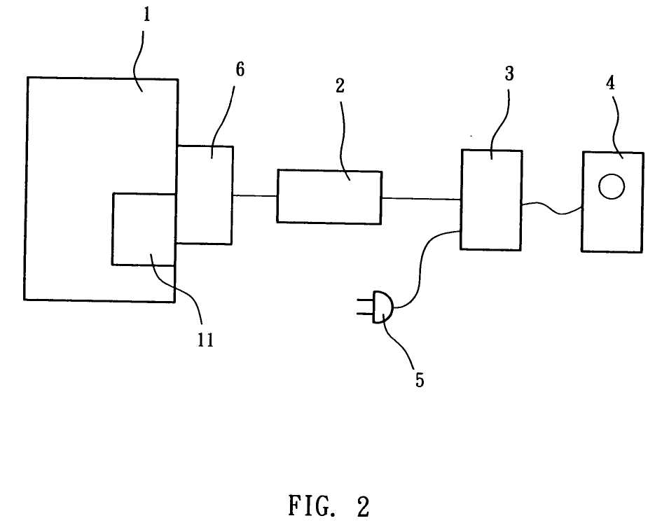

Fig. shows the systematic diagram of the fully digital audio output device of this invention. In this figure, components that are same as those in FIGS. 1 and 2 are labeled with the same numbers. As shown in this figure, the fully digital audio output device of this invention comprises: a communication interface 10 connector to electrically connect a communication interface 11 of a computer 1; a communication interface 6 converter to convert signals and data obtained from said communication interface connector 10 into a first format and to convert signals and data to be transferred to said communication interface 11 into a second format; a digital signal converter 7 to convert said first format digital audio signals into a third format and to output such third format signals; a buffer memory 8 to store said second format digital audio signals of said communication interface converter 6 to be processed by said digital signal converter; and a power management circuit 9 to manage to output current obtained from said communication interface connector 10 along with said third format digital signals of said digital signal converter. As shown in this figure, the third format digital signal is used to drive the speaker 4 directly.

In the fully digital audio output device of this invention, the communication interface connector 10 is designed according to the standards of the communication interface 11 of the computer. The USB interface is one of the most popular standards. As a result, the communication interface connector 10 may be a USB connector. In such a case, the first format digital signal may be in the USB standard. In addition, other interfaces which are already invented or not, such as PS2, PCMCIA etc., may also be applied. The only restriction is that the present invention uses the power supplied by the communication interface 11 to drive the speaker 4. The communication interface shall be able to supply at least 5V voltage and 500 mA current.

The communication interface converter 6 is used to convert signals and data to be transferred between the digital signal converter 7 and the communication interface 11 of the computer 1. It shall provide the capability of converting signals and data between the first format that is acceptable by the communication interface 11 and the second format that is acceptable by the digital signal converter 7, respectively. For example, when the communication interface 11 is an USB interface, whereby the first format is the USB format, and the digital signal converter 7 converts pulse code modulation (PCM) signals generated by the computer 1 into pulse width modulation (PWM) signals, whereby the second format is the PCM format and the third format is the PWM format, the communication interface converter 6 shall be able to convert signals and data between the USB format and the PCM format.

The major function of the digital signal converter 7 is to convert digital signals generated by the computer 1 into signals that is able to drive the speaker 4 directly. In general, signals generated by the computer 1 may be PCM codes and signals that are able to drive the speaker 4 may be PWM signals. As a result, the digital signal converter 7 may be a PCM to PWM converter. Such converters are already available in the market and are low-cost components. They are applicable in this invention. Besides the PCM to PWM converter, other digital signal converters, such as PCM to PAM (pulse amplitude modulation) converter, are also applicable in this invention, as long as the converter is able to convert the audio signals of the computer into digital signals suited in driving the speaker 4.

In order to avoid interruption of audio output, a buffer memory 8 is provided to temporarily store digital audio signals and data generated by the computer 1. If necessary, a sensing circuit (not shown) may be provided to generate an alert when buffer under run is found in the buffer memory 8, such that the computer may regenerate the audio signals. As the buffering technology belongs to the known art, detailed description thereof is thus omitted.

The digital audio signals so generated shall be able to drive the speaker 4 directly. A power management circuit 9 is so provided to achieve such purpose. Such a power management circuit may be a 3V stabilizer IC or other similar circuits.

The fully digital audio output device as described above may be connected to the computer 1 by plugging the communication interface connector 10 to the slot or jack of the communication interface 11 of the computer 1. Connect the input of the speaker 4 to the output of the digital signal converter 7. The sound represented by the digital audio signals generated by the computer 1 may thus be generated from the speaker 4. In the present invention, the speaker may be a earphone or other similar audio output equipments.

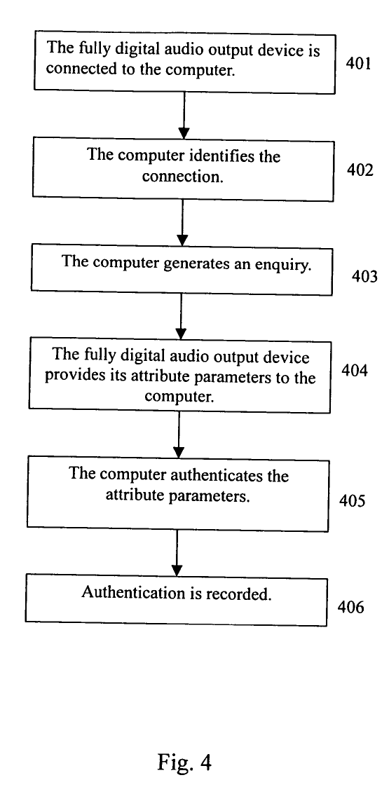

FIG. 4 shows the flowchart of the initialization of the fully digital audio output device of this invention. As shown in this figure, at 401 the fully digital audio output device of this invention is connected to the computer 1 by plugging the communication interface connector 10 to the slot or jack of the communication interface 11 of the computer 1. At 402 the computer 1 identifies the connection and generates an enquiry at 403. At 404 the fully digital audio output device provides its attribute parameters to the computer 1, which parameters may include acceptable formats for digital audio signals, acceptable number of bytes for each signal etc. At 405 the computer 1 authenticates the attribute parameters and records same at 406. At this step, the computer changes the registered audio output device into the fully digital audio output device. Initialization of the fully digital audio output device is thus completed. The fully audio output device is then able to replay the digital audio signals of the computer.

As the present invention has been shown and described with reference to preferred embodiments thereof, those skilled in relevant arts will recognize that other changes may be made therein without departing from the concept and scope of the invention.

1. A fully digital output device, comprising:
a communication interface connector to electrically connect a communication interface of a computer;
a communication interface converter to convert signals and data obtained from said communication interface connector into a first format and to convert signals and data to be transferred to said communication interface into a second format;
a digital signal converter to convert said first format digital audio signals into a third format and to output such third format signals;
a buffer memory to store said second format digital audio signals of said communication interface converter to be processed by said digital signal converter; and
a power management circuit to manage to output current obtained from said communication interface connector along with said third format digital signals of said digital signal converter;
wherein said third format digital signal is used to drive a speaker directly.

2. The fully digital audio signal output device according to claim 1, further comprising a speaker, to be driven by said third format digital signal to generate sound.

3. The fully digital audio signal output device according to claim 1 or 2, wherein said first format is USB format.

4. The fully digital audio signal output device according to claim 1 or 2, wherein said second format is PCM format.

5. The fully digital audio signal output device according to claim 1 or 2, wherein said third format is selected from the PWM format or the PAM format.

6. The fully digital audio signal output device according to claim 1 or 2, wherein said first format is one selected from the USB format, the PS2 format or the PCMCIA format.
